(19) United States
(12) Patent Application Publication
(10) Pub. No.: US 2012/0314043 A1
(43) Pub. Date: Dec. 13, 2012

(54) MANAGING MULTIMEDIA CONTENTS USING GENERAL OBJECTS

(76) Inventors: Jaehoon Jung, Seoul (KR); Seonghoon Hahm, Seoul (KR); Woohyun Paik, Seoul (KR); Joomin Kim, Seoul (KR)

(21) Appl. No.: 13/511,949

(22) PCT Filed: Nov. 4, 2010
(86) PCT No.: PCT/KR2010/007739

§ 371 Date: May 24, 2012

(30) Foreign Application Priority Data
Nov. 25, 2009 (KR) 10-2009-0114543

(51) Int. Cl. H04N 7/18; G06K 9/46

(52) U.S. Cl. 348/61; 382/190; 348/E07.085

(57) ABSTRACT

The embodiment maps multimedia contents to an image of a general object and uses the object image as a shortcut. The contents can be played/deleted/moved through the object image to which the contents are mapped.

### TECHNICAL FIELD

The present invention relates to a user interface for controlling multimedia contents such as moving pictures and images.

In particular, the present invention photographs a general object (hereinafter simply referred to as an object) around a user, maps multimedia contents to the resulting object image, and uses the object image as a shortcut to the multimedia contents. The present invention may use the object image to play the multimedia contents or perform various controls.

### BACKGROUND ART

The scale-up of storages has made it difficult to classify files for storage purposes. Also, Internet accessibility has increased the amount of contents accessed, thus making it difficult to classify files for the purpose of shortcut use.

In order to play contents, the related art uses a method of accessing the contents through a file system of a device storing the contents. However, this is not a user-based system, is not intuitive to users, and needs very difficult and troublesome operations to control various complex contents.

What is therefore required is a method for accessing various multimedia contents more conveniently and intuitively.

### DISCLOSURE OF INVENTION

### Technical Problem

Embodiments provide a method for controlling/storing multimedia contents more intuitively by mapping the multimedia contents to actual object images.

Embodiments also provide a method for controlling contents intuitively as if arranging actual objects.

### Solution to Problem

In an embodiment, a playback device includes: an image receiving unit receiving an image of an object; a control unit extracting identification information of the object from the received image and performing a mapping-related operation between the object and contents on the basis of the extracted identification information; a storage unit storing the contents and the mapping information between the object and the contents; a user input unit receiving a user input; and an image processing unit processing the contents into a displayable signal.

In another embodiment, a playback device includes: a Near Field Communication (NFC) unit receiving identification information of an object; a control unit performing a mapping-related operation between the object and contents on the basis of the received identification information; a storage unit storing the contents and the mapping information between the object and the contents; a user input unit receiving a user input; and an image processing unit processing the contents into a displayable signal.

In further another embodiment, a remote control device connected wirelessly to other devices to communicate data includes: a camera unit photographing an image of an object; a control unit extracting identification information of the object from the photographed image; a user input unit receiving a user input; a Near Field Communication (NFC) unit transmitting the extracted object identification information or the user input to the other devices; and a display unit displaying the photographed object image.

In still further another embodiment, a playback device includes: an image receiving unit receiving an image of an object; a control unit extracting identification information of the object from the image of the object; a Near Field Communication (NFC) unit transmitting the identification information and receiving mapping-related information between the object and contents; a user input unit receiving a user input; and an image processing unit processing the mapping-related information between the object and the contents into a displayable signal.

In still further another embodiment, a multimedia data managing server connected wirelessly to one or more playback devices or remote control devices to manage multimedia data includes: a Near Field Communication (NFC) unit receiving identification information of an object; a control unit performing a mapping-related operation between the object and contents on the basis of the received object identification information; a storage unit storing the mapping information between the object and the contents; and a user input unit receiving a user input.

In still further another embodiment, a method for providing a user interface for control of multimedia contents in a playback device that stores contents and the mapping information between an object and the contents includes: receiving an image of an object; extracting identification information of the object from the received image; displaying a mapping-related menu between the object and the contents; receiving a selection input from a user; and performing a mapping-related operation between the object and the contents on the basis of the extracted identification information.

In still further another embodiment, a method for providing a user interface for control of multimedia contents in a playback device that stores contents and the mapping information between an object and the contents includes: receiving identification information of an object; displaying a mapping-related menu between the object and the contents; receiving a selection input from a user; and performing a mapping-related operation between the object and the contents on the basis of the extracted identification information.

The details of one or more embodiments are set forth in the accompanying drawings and the description below. Other features will be apparent from the description and drawings, and from the claims.

### Advantageous Effects of Invention

As described above, the embodiments make it possible to play/control multimedia contents more intuitively by mapping contents to an image of a general object around a user.

The embodiments also make it possible to play/control contents intuitively as if arranging actual objects.

### BRIEF DESCRIPTION OF DRAWINGS

FIG. 1 illustrates the concept of mapping contents according to an exemplary embodiment.

FIG. 2 illustrates a method for controlling contents by object recognition according to an exemplary embodiment.

FIG. 3 illustrates a block diagram of a playback device according to an exemplary embodiment.

FIG. 4 illustrates an object identification method according to an exemplary embodiment.

FIG. 5 illustrates a menu screen for controlling contents according to an exemplary embodiment.

FIG. 6 illustrates a screen for browsing contents mapped to an object according to an exemplary embodiment.

FIG. 7 is a flow diagram illustrating a method performed by a playback device of FIG. 1 according to an exemplary embodiment.

FIG. 8 illustrates a method for controlling contents by object recognition according to another exemplary embodiment.

FIG. 9 illustrates a block diagram of a playback device of FIG. 8 according to an exemplary embodiment.

FIG. 10 illustrates a block diagram of a remote control device according to an exemplary embodiment.

FIGS. 11 and 12 illustrate the external appearance of a remote control device according to an exemplary embodiment.

FIG. 13 is a method of identifying a playback device according to an exemplary embodiment.

FIGS. 14 and 15 illustrate a method for displaying contents information with virtual reality according to an exemplary embodiment.

FIG. 16 is a flow diagram illustrating a method performed by a playback device of FIG. 8 according to an exemplary embodiment.

FIG. 17 is a flow diagram illustrating a method performed by a remote control device of FIG. 8 according to an exemplary embodiment.

FIG. 18 illustrates a method for controlling contents by using object recognition according to an exemplary embodiment.

FIG. 19 is a block diagram of a multimedia data managing server of FIG. 18 according to an exemplary embodiment.

FIG. 20 is a flow diagram illustrating a method performed by a playback device of FIG. 18 according to an exemplary embodiment.

FIG. 21 is a flow diagram illustrating a method performed by a multimedia data managing server of FIG. 18 according to an exemplary embodiment.

FIG. 22 illustrates a method for controlling contents by using object recognition according to another exemplary embodiment.

FIG. 23 is a flow diagram illustrating a method performed by a playback device of FIG. 22 according to an exemplary embodiment.

FIG. 24 is a flow diagram illustrating a method performed by a server of FIG. 22 according to an exemplary embodiment.

FIG. 25 illustrates a method for controlling contents by using object recognition according to further another exemplary embodiment.

FIG. 26 is a flow diagram illustrating a method performed by a server of FIG. 25 according to an exemplary embodiment.

FIG. 27 illustrates a method for controlling contents by using object recognition according to still further another exemplary embodiment.

### BEST MODE FOR CARRYING OUT THE INVENTION

Reference will now be made in detail to the embodiments of the present disclosure, examples of which are illustrated in the accompanying drawings.

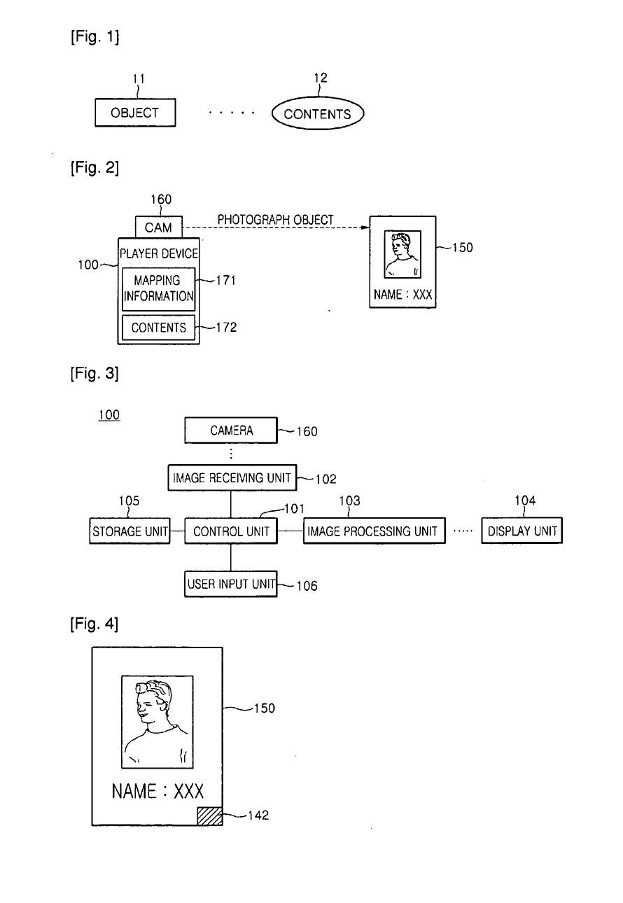

FIG. 1 illustrates the concept of mapping contents according to an exemplary embodiment.

According to an exemplary embodiment, multimedia contents 12 (hereinafter referred to as contents) such as moving pictures, images and audio files may be mapped a general object 11 (hereinafter referred to as an object). The object 11 to which the contents 12 are mapped (hereinafter referred to as a contents-mapped object) may serve as a shortcut of the contents. That is, a user may use the object 11 to control the contents 12.

When an image of the contents-mapped object is photographed and recognized by image recognition technology, the mapping information may be referred to know which contents are mapped to the object. The contents mapped to the object may be played, moved or browsed, or additional contents may be mapped to the object.

In an exemplary embodiment, an object is substantially related to contents mapped to the object. For example, data picture contents with a lover may be mapped to a picture of the lover, movie contents may be mapped to a poster of the movie, and pictures photographed in a group meeting may be mapped to a memo pad for the group meeting promise.

By mapping the contents as described above, the user can intuitively recognize, from the object, which contents are mapped to the object.

FIG. 2 illustrates a method for controlling contents by object recognition according to an exemplary embodiment.

Referring to FIG. 2, a playback device 100 is mounted with a camera 160 and stores mapping information 171 and contents 171. Herein, the mapping information means information representing which contents are mapped to which object.

The playback device 100 includes any device that can play one or more of multimedia contents such as moving pictures, music and pictures. For example, the playback device 100 may include any playback device such as TVs, games, digital picture frames, MP3 players and PCs.

The camera 160 mounted on the playback device 100 may be used to photograph a general object, i.e., an object 150. This embodiment illustrates a staff certificate as the object 150. However, an object of an exemplary embodiment may be any photographable object and may be substantially related to the contents to be mapped to the object.

FIG. 3 illustrates a block diagram of a playback device according to an exemplary embodiment.

Referring to FIG. 3, a playback device 100 according to an exemplary embodiment may include: an image receiving unit 102 receiving an image of an object; a control unit 101 extracting identification information of the object from the received image and performing a mapping-related operation between the object and contents on the basis of the extracted identification information; a storage unit 105 storing the contents and the mapping information between the object and the contents; a user input unit 106 receiving a user input; and an image processing unit 103 processing the contents into a displayable signal.

The image receiving unit 102 may include a camera 160 or a camera connecting unit. That is, the camera 160 may be integrated with the playback device 100 or may be connected by any connection unit.

The control unit 101 controls the playback device 100 and performs a signal processing operation for playing contents. The control unit 101 may be a processor, a microprocessor, or a general-purpose or dedicated processor.

The image processing unit 103 processes contents into a displayable signal and provides the same to a display unit 104. According to an exemplary embodiment, the display unit 104 and the image processing unit 103 may be integrated. That is, the display unit 104 may be included in the playback device 100.

The storage unit 105 may store the mapping information and the contents. The storage unit 105 may also store data necessary for general operations of the playback device 100. The storage unit 105 may be any storage medium such as flash ROM, EEPROM and HDD.

The user input unit 106 receives a user input. The user input unit 106 may be various buttons equipped outside the playback device 100, input devices such as mouse and keyboard connected to the playback device 100, or a remote control input receiving unit for receiving a remote control input from the user.

FIG. 4 illustrates an object identification method according to an exemplary embodiment.

According to an exemplary embodiment, a camera is used to photograph an image of an object, and the object is identified by the photographed image. The photographed object image may be used to identify the object, but it may increase the data processing amount. Thus, as illustrated in FIG. 4, an identifier 142 is added to an object 150 to reduce the number of recognition errors and the data processing amount for recognition. The identifier 142 may include a unique code representing the object 150. For example, the identifier 142 may be a bar code, a unique character, or a unique number. The object 150 may be identified by photographing/recognizing the identifier 142 without the need to photograph the entire object.

In FIG. 2, when the camera 160 photographs an image of a staff certificate 150, the control unit 101 of the playback device 100 extracts the identification information from the image. The contents mapped may be searched from the mapping information 171 on the basis of the extracted identification information, and various operations related to the mapping relationship between the object and the contents (hereinafter referred to as mapping-related operations) may be performed on the searched contents. The mapping-related operations may include operations of mapping contents to an object, playing the mapped contents, and browsing the mapped contents.

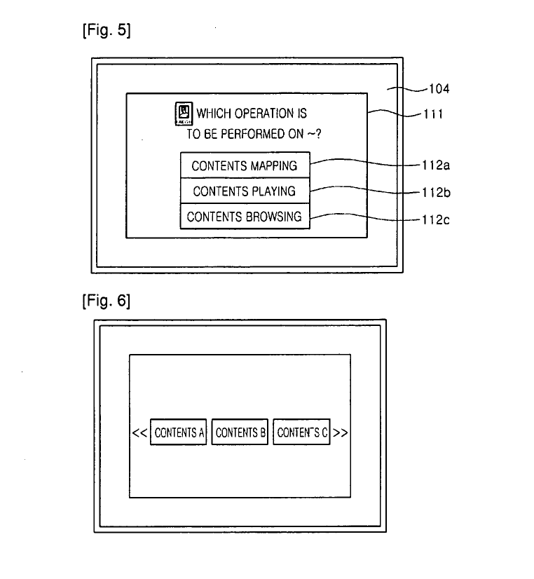

FIG. 5 illustrates a menu screen for controlling contents according to an exemplary embodiment. FIG. 6 illustrates a screen for browsing contents mapped to an object according to an exemplary embodiment.

FIG. 5 illustrates a menu screen 111 that is displayed on a display unit 104 of a playback device 100 when the playback device 100 recognizes a staff certificate 150 by using a TV mounted with a camera. The menu screen 111 may include selection menus 112a, 112b and 112c and a message for inquiring which operation will be performed on the recognized object. The contents mapping menu 112a is to map new contents to the identified object, to delete the mapped contents, or to map additional contents. The contents playing menu 112b is to play the contents mapped to the identified object. The contents browsing menu 112c is to display a list of contents mapped to the identified object. When the contents browsing menu 112c is selected, a contents list may be displayed as illustrated in FIG. 6 and then the user may select contents from the contents list to perform various control operations such as playing, deleting and moving.

The selection menus 112a, 112b and 112c are merely exemplary and may vary according to embodiments.

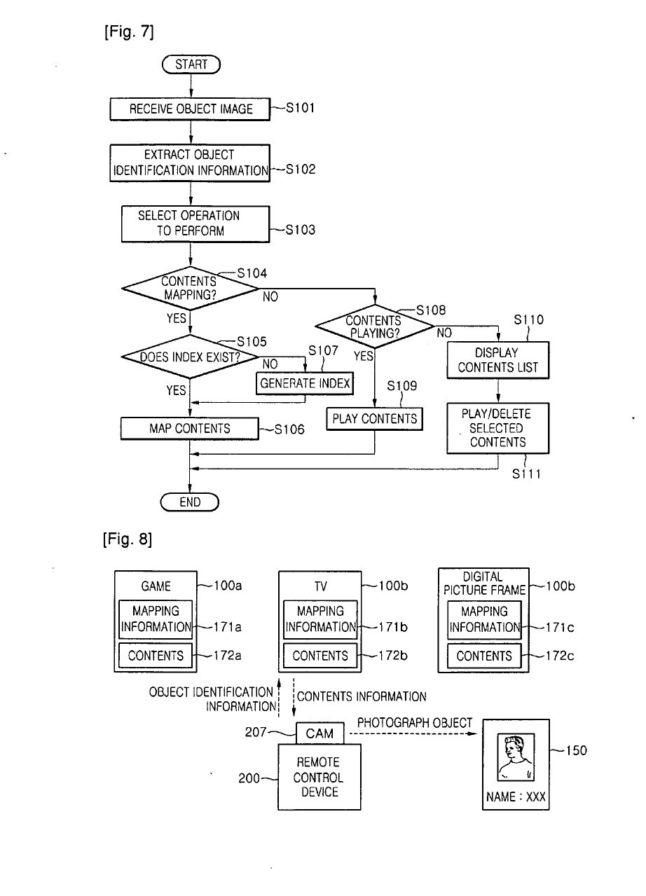

FIG. 7 is a flow diagram illustrating a method performed by the playback device of FIG. 1 according to an exemplary embodiment.

In step S101, the method photographs an image of an object by using a camera mounted on a playback device, or receives an image of an object by using a camera connected to a playback device.

In step S102, the method extracts identification information of the object from the photographed image. The identification information of the object may be the partial or entire image of the object, and may be a unique code included in an identifier added to the object as described above.

In step S103, the method displays a menu to a user, and receives a selection input of an operation to be performed on an identified object and contents mapped to the identified object. That is, the method receives a selection input for selecting one of the operations related to the mapping relationship between the identified object and the contents.

In step S104, the method determines whether the selected operation is contents mapping. If the selected operation is contents mapping (in step S104), the method proceeds to step S105. In step S105, the method determines whether the index of the identified object is present in the mapping information stored in the playback device. If the index of the identified object is not present in the mapping information (in step S105), the method generates the index and proceeds to step S106. On the other hand, the index of the identified object is present in the mapping information (in step S105), the method proceeds directly to step S106. In step S106, the method maps the contents selected by the user to the identified object. The contents selected by the user may be displayed on a separate search screen to be selected by the user, or may be the contents displayed in the playback device at the identification of the object.

In step S108, the method determines whether the selected operation is contents playing. If the selected operation is contents playing (in step S108), the method proceeds to step 109. In step S109, the method plays the contents mapped to the object. If the contents mapped to the object are plural, the plural contents may be sequentially played.

If the selected operation is contents browsing (in step S108), the method proceeds to step 110. In step S110, the method displays a list of contents stored in the playback device. In step S111, the user may select contents from the contents list, and may perform various control operations on the selected contents, such as playing, deleting and moving operations.

### MODE FOR THE INVENTION

FIG. 8 illustrates a method for controlling contents by object recognition according to another exemplary embodiment.

In FIG. 8, it is assumed that there are a plurality of playback devices 100a, 100b and 100c. The playback devices 100a/100b/100c store an object, mapping information 171a/171b/171c representing information of contents mapped to the object, and contents 172a/172b/172c.

A remote control device 200 is mounted with a camera. A user may use the remote control device 200 to control the playback devices 100a, 100b and 100c, and the remote control device 200 and the playback devices 100a, 100b and 100c may be connected to transmit/receive data by near field wireless communication. The near field wireless communication may include any communication scheme capable of transmitting/receiving data, and may be one of WiFi communication, Bluetooth Communication, RF communication, ZigBee Communication and Near Field Communication (NFC).

In FIG. 8, the user photographs an object 150 by the camera 207 of the remote control device 200, extracts identification information of the object 150, and transmits the extracted identification information to one of the playback devices. Herein, the extracted identification information may be transmitted to the playback device facing the camera 207. That is, the user may use the camera 207 to select the playback device to receive the identification information. When the camera 207 recognizes a playback device, the identification information may be transmitted to the playback device.

The playback device receiving the identification information, for example, a TV 100b transmits the contents information mapped to the object to the remote control device 200. The remote control device 200 displays the received contents information on a display unit mounted on the remote control device 200. Herein, as described below, the remote control device 200 may generate a virtual image on the basis of the received contents information and display the same together with the identified contents image. Thus, the user may use the remote control device 200 to know information about the contents mapped to the identified object 150, and may perform various other control operations.

Also, the user may direct the camera of the remote control device 200 toward the object 150 to identify the object 150. Thereafter, when it is directed toward one of the playback devices, for example, the TV 100b, the camera can recognize the TV 100b. When the object 150 and the TV 100b are successively recognized, the contents mapped to the object 150 may be played by the TV 100b without the need for a separate user input.

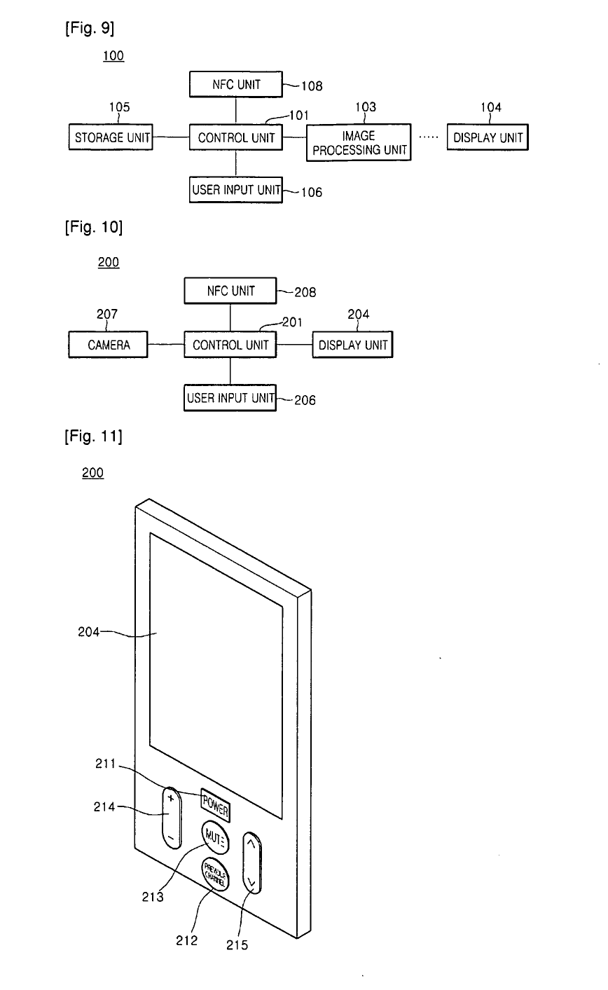

FIG. 9 illustrates a block diagram of the playback device of FIG. 8 according to an exemplary embodiment.

Referring to FIG. 9, a playback device 100 according to an exemplary embodiment may include: a Near Field Communication (NFC) unit 108 receiving identification information of an object; a control unit 101 performing a mapping-related operation between the object and contents on the basis of the received identification information; a storage unit 105 storing the contents and the mapping information between the object and the contents; a user input unit 106 receiving a user input; and an image processing unit 103 processing the contents into a displayable signal. Other elements are the same as those of FIG. 3, but the NFC unit 108 is provided instead of the image receiving unit. That is, a camera is not mounted on or connected to the playback device of FIG. 8.

FIG. 10 illustrates a block diagram of a remote control device according to an exemplary embodiment.

Referring to FIG. 10, a remote control device 200 according to an exemplary embodiment may be connected to playback devices to communication data. The remote control device 200 may include: a camera unit 207 photographing an image of an object; a control unit 201 extracting identification information of the object from the photographed image; a user input unit 206 receiving a user input; a Near Field Communication (NFC) unit 208 transmitting the extracted object identification information or the user input to the other devices; and a display unit 204 displaying the photographed object image.

The NFC unit 208 communicates with the NFC 108 of the playback device illustrated in FIG. 9. If the user input unit 106 of FIG. 9 is a remote control input receiving unit, the NFC unit 208 also transmits a control command of the playback device.

The user input unit 206 may include key buttons mounted on the remote control device, and may be a touchscreen when it is mounted with a touchscreen.

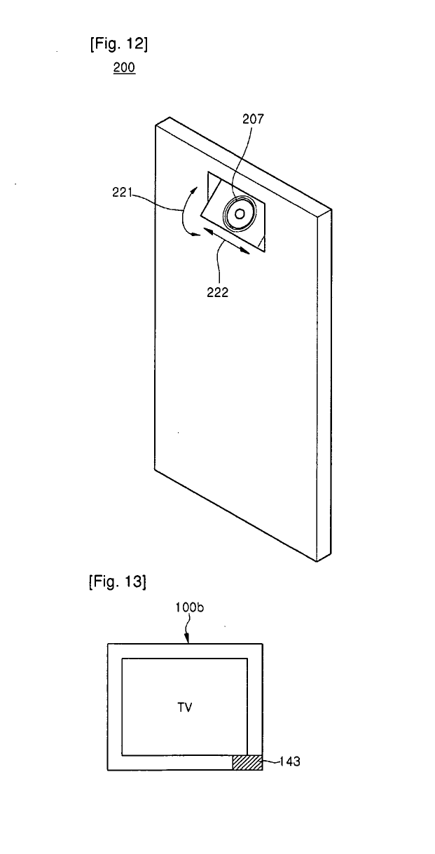

FIGS. 11 and 12 illustrate the external appearance of the remote control device 200 according to an exemplary embodiment. FIG. 11 is a front-side perspective view of the remote control device 200, and FIG. 12 a rear-side perspective view of the remote control device 200. According to an exemplary embodiment, the front side of the remote control device 200 may face a user, and the rear side of the remote control device 200 may face a target device to be controlled.

Referring to FIG. 11, a display unit 204 is disposed at the front side of a remote control device 200. The display unit 204 may be a touchscreen.

Other control buttons may be disposed at other parts except the display unit 204. The control buttons may include a power button 211, a channel control button 214, a volume control button 215, a mute button 213, and a previous channel button 212. Besides, the control buttons may further include various buttons according to the types of target devices. According to an exemplary embodiment, a touchscreen may be used as the display unit 204, and other buttons except one or more control buttons may be displayed on the touchscreen.

Referring to FIG. 12, a camera 207 is disposed at the rear side of a remote control device 200. In an operation mode, the camera 207 may face in the direction of photographing a target device, i.e., a playback device. The camera 207 and the display unit 204 may face in the opposite directions. That is, the camera 207 may face the target device to be controlled, and the display unit 204 may face the user.

According to an exemplary embodiment, an actuator may be connected to the camera 207 to provide a direction change in a vertical direction 221 or a horizontal direction 222.

FIG. 13 is a method of identifying a playback device according to an exemplary embodiment.

Like the case of using a unique identifier to identify an object as described above, a unique identifier 143 may be used to recognize the playback device 100b by the camera. Thus, it is possible to reduce the recognition error probability and the data processing amount.

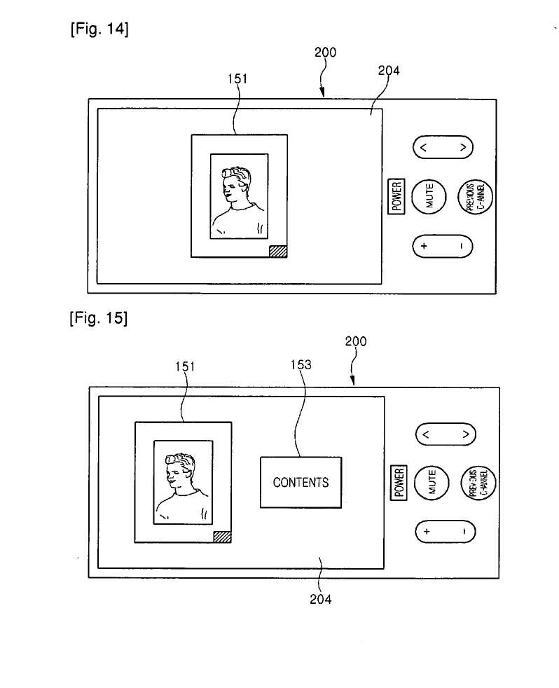

FIGS. 14 and 15 illustrate a method for displaying contents information with virtual reality according to an exemplary embodiment.

First, a remote control device 200 is used to photograph an object 150, and identification information is extracted from an object image. When the remote control device 200 photographs an object image, a photographed object image 151 may be displayed on a display unit of the remote control device 200 as illustrated in FIG. 14. When the extracted identification information is transmitted to a selected playback device 102b, the playback device 120b transmits information about the contents mapped to the object 150 to the remote control device 200. As illustrated in FIG. 15, the remote control device may display a virtual image 153 together with the object image 151 on the basis of the received contents information. That is, in FIG. 15, the object image 151 is an actual image photographed by the camera of the remote control device 200, and the virtual image 153 is a virtual image generated on the basis of the contents information received from the playback device 102b of the remote control device 200. According to an exemplary embodiment, instead of streaming the contents, information about the contents, such as title, file size and storage location, may be displayed with virtual reality. From this configuration, the use may photograph the object by the remote control device 200 to identify the contents mapped to the object.

According to an exemplary embodiment, if the display unit 204 of the remote control device 200 is a touchscreen, when the user selects a contents image 153 in the state of FIG. 15, the menu may be displayed/used to perform various control operations such as operations of playing/deleting/mobbing the contents.

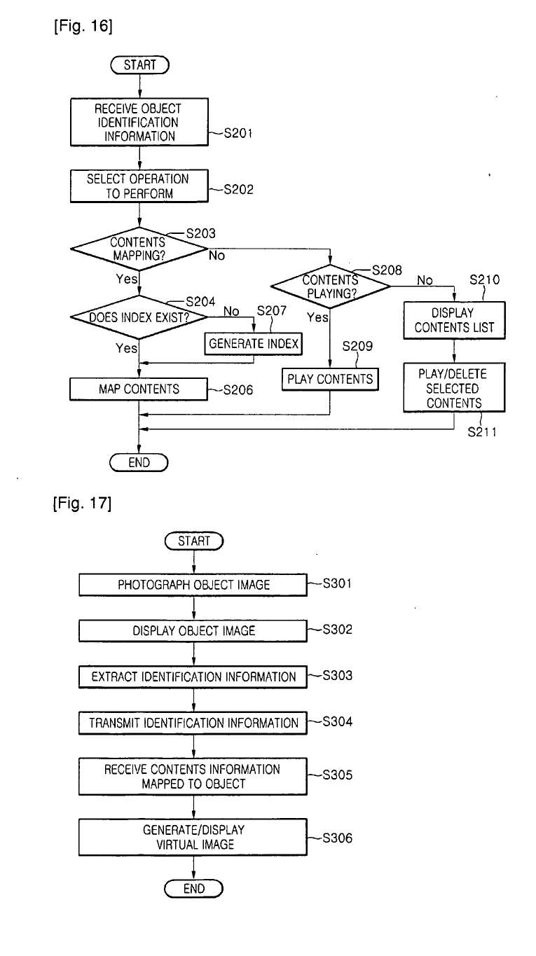

FIG. 16 is a flow diagram illustrating a method performed by the playback device of FIG. 8 according to an exemplary embodiment.

In step S201, the method receives identification information of an object from the remote control device. In step S202, the user performs a necessary operation through the remote control device. The subsequent steps S203˜S210 are identical to the steps S104˜S111 of FIG. 7.

FIG. 17 is a flow diagram illustrating a method performed by the remote control device of FIG. 8 according to an exemplary embodiment.

The method photographs an image of an object in step S301, and displays the photographed object image in step S302. In step S303, the method extracts identification information from the photographed object image. In step S304, the method transmits the extracted identification information to one of the playback devices. Herein, the playback device to receive the extracted identification information may be selected by directing it toward the camera of the remote control device, and the identification information may be transmitted to the playback device identified by the camera.

In step S305, the method receives the contents information mapped to the object from the playback device. In step S306, the method generates a virtual image on the basis of the received contents information, and displays the same together with the object image.

According to an exemplary embodiment, an object mapping-related operation may be performed through a multimedia data managing server connected by wireless communication (e.g., near field wireless communication) to the playback device and/or the remote control device.

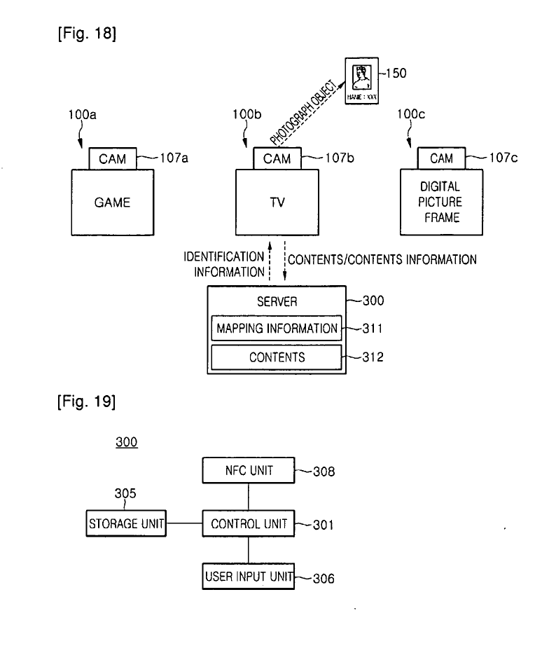

FIG. 18 illustrates a method for controlling contents by using object recognition according to an exemplary embodiment.

In this embodiment, a multimedia managing server 300 stores mapping information and contents. Also, the server 300 performs a mapping operation between an object and contents, i.e., an operation of mapping new contents and providing mapping information. Also, cameras 107a/107b/107c are mounted on or connected to playback devices 100a/100b/100c.

In FIG. 18, the user photographs an image of the object 150 by the camera 107b connected to the TV 100b (i.e., one of the playback devices), the playback device may transmit identification information of the object 150 to the server 300. The server 300 uses the mapping information 311 to search the contents information mapped to the received identification information and transmits the searched contents information to the TV 100b. If there is no index of an identified object, or if it is an object not registered in the server 300, the method may generate the index or may map the contents selected by the user or played by the TV 100b.

The server 300 transmits information about the contents mapped to the object to the TV 100b. The TV 100b may display a contents control menu (e.g., a menu illustrated in FIG. 5) to a user, and the user may use the menu to perform an operation such as contents mapping, contents playing or contents browsing.

If the user selects contents playing, the server 300 transmits the contents 312 to the TV 100b to play the contents in the TV 100b.

FIG. 19 is a block diagram of the multimedia data managing server of FIG. 18 according to an exemplary embodiment.

Referring to FIG. 19, a multimedia data managing server 300 according to an exemplary embodiment may be wirelessly connected to one or more playback devices or remote control devices. The multimedia data managing server 300 may include: a Near Field Communication (NFC) unit 308 receiving identification information of an object; a control unit 301 performing a mapping-related operation between the object and contents on the basis of the received object identification information; a storage unit 305 storing the mapping information between the object and the contents; and a user input unit 306 receiving a user input. The NFC unit is connected to the playback devices to communicate identification information, contents or contents information, and may communicate with the remote control device as described below.

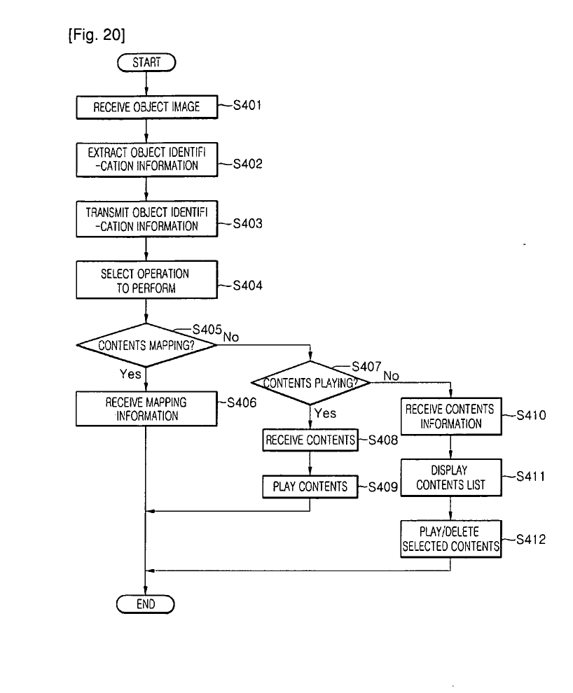

FIG. 20 is a flow diagram illustrating a method performed by the playback device 100a/100b/100c of FIG. 18 according to an exemplary embodiment.

In step S401, the method receives an object image from a camera mounted on or connected to a playback device. In step S402, the method extracts identification information from the received object image. In step S403, the method transmits the extracted identification information to the server 300. In step S404, the method receives information about the presence/absence of contents mapped to the object from the server 300. Thereafter, if there are mapped contents, the method displays the menu of FIG. 5 to the user to select an operation to perform.

In step S404, the method determines whether an operation to perform is contents mapping. If an operation to perform is contents mapping (in step S404), the method proceeds to step S406. In step S406, the method causes the server to perform a mapping operation and receives the mapping result. If an object index is present, the server 300 may perform a mapping operation. On the other hand, if an object index is not present, the server 300 may generate the index and then perform a mapping operation.

In step S407, the method determines whether an operation to perform is contents playing. If an operation to perform is contents playing (in step S407), the method proceeds to step S408. In step S408, the method receives contents from the server 300. In step S409, the method plays and outputs the received contents.

If an operation to perform is other operation (e.g., contents browsing), the method receives contents information from the server in step S410 and displays a contents list in step S411 on the basis of the received contents information. In step S412, the user may select contents from the displayed contents list to perform various control operations such as operations of playing, deleting and moving the contents.

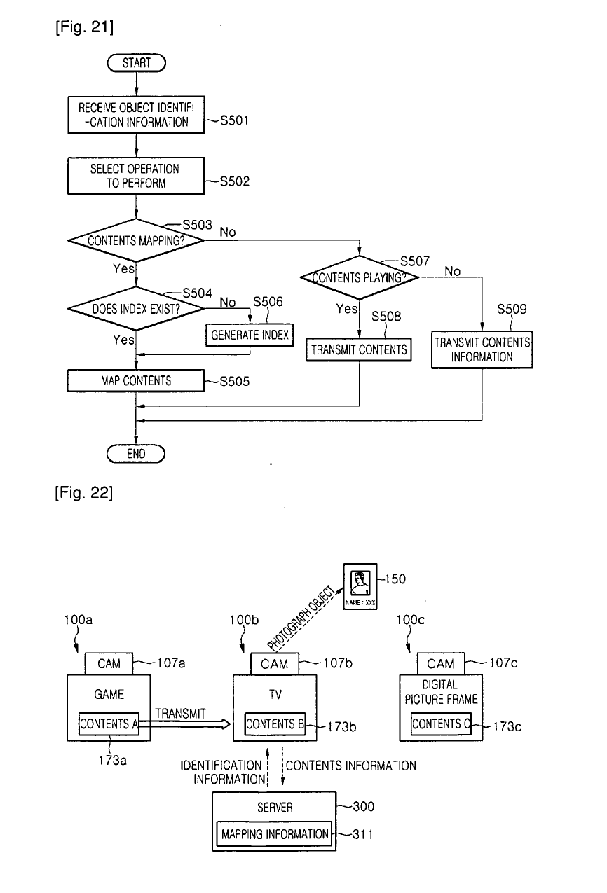

FIG. 21 is a flow diagram illustrating a method performed by the multimedia data managing server 300 of FIG. 18 according to an exemplary embodiment.

In step S501, the method receives object identification information from one of the playback devices that received an object image. In step S502, the method selects an operation to be performed by the user. In step S503, the method determines whether an operation to perform is contents mapping. If an operation to perform is contents mapping (in step S503), the method proceeds to step S504. In step S504, the method determines whether an index of an identified object is present. If an index of an identified object is present, the method maps contents in step S505. On the other hand, if an index of an identified object is not present, the method generates the index to map contents in step S506.

In step S507, the method determines whether an operation to perform is contents playing. If an operation to perform is contents playing (in step S507), the method transmits contents to the playback device in step S508. On the other hand, if an operation to perform is contents browsing (in step S507), the method transmits contents information including a contents list to the playback device in step S509.

FIG. 22 illustrates a method for controlling contents by using object recognition according to another exemplary embodiment.

In this embodiment, the server 300 stores mapping information and the playback devices 100a/100b/100c store contents A/B/C. Cameras 107a, 107b and 107c are mounted on or connected to the playback devices. The playback device mounted with the camera photographing the object 150, for example, the TV 100b receives an object image, extracts identification information and transmits the extracted identification information to the server 300. The server 300 transmits contents information mapped to the object to the TV 100b on the basis of mapping information. The contents information may include not only information about the presence/absence of contents mapped to the object, but also information about the location of the contents, i.e., information about which playback device the contents are stored in. The TV 100b displays a menu similar to that of FIG. 5 on the basis of the contents information to enable the user to select an operation. If the contents mapped to the object 150 are the contents B 173b stored in the TV 100b, the TV 100b may play the contents or perform other operation without communicating with other playback devices 100a and 100c.

However, if the contents mapped to the object 150 are the contents A 173a stored in other playback device such as a game 100a, the TV 100b may receive contents directly from the game 100a or through the server 300 prior to playing the same. According to an exemplary embodiment, the game 100a may also play the contents.

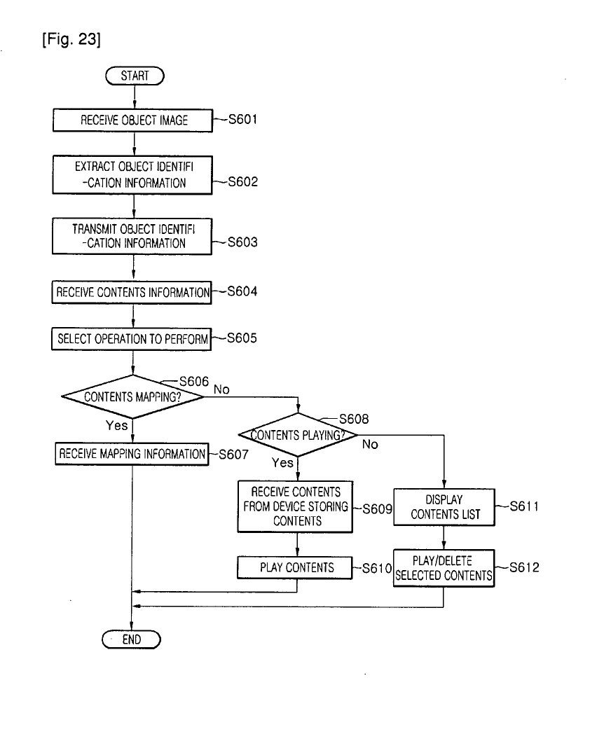

FIG. 23 is a flow diagram illustrating a method performed by the TV 100b of FIG. 22 according to an exemplary embodiment, if contents are stored in each playback device.

In step S601, the method photographs an object 150 by a camera 107b mounted on or connected to a TV 100b and receives an image of the object 150. In step S602, the method extracts identification information of the object from the received image. In step S603, the method transmits the extracted identification information to the server 300. In step S604, the method receives contents information from the server 300. In step S605, the method displays a menu of FIG. 5 to cause the user to select an operation to perform.

In step S606, the method determines whether an operation to perform is contents mapping. If an operation to perform is contents mapping (in step S606), the method proceeds to step S607. In step S607, the method may cause the server to perform a mapping operation and may receive information about the mapping result.

In step S608, the method determines whether an operation to perform is contents playing. If an operation to perform is contents playing (in step S608), the method proceeds to step S609. In step S609, the method receives contents from the device storing the contents, for example, the game 100a. In step S610, the method plays the received contents. If an operation to perform is contents browsing, the method proceeds to step S611. In step S610, the method displays a contents list on the basis of the received contents information. In step S612, the user selects contents from the displayed contents list to perform control operations such as operations of playing, deleting and moving the contents.

FIG. 24 is a flow diagram illustrating a method performed by the server 300 of FIG. 22 according to an exemplary embodiment.

In step S701, the method receives identification information of an object from one of the wirelessly-connected playback devices. In step S702, the method searches mapping information and transmits contents information mapped to the identified objet to the playback device. In step S703, the user selects an operation to perform. If an operation to perform is contents mapping (in step S704), the method proceeds to step S705. In step S705, the method determines whether an index of the object is present. If an index of the object is present, the method maps contents in step S706. On the other hand, if an index of the object is not present, the method generates the index to map contents in step S707. If an operation to perform is an operation other than contents mapping (in step S704), the server 300 ends the process because there is no operation to perform.

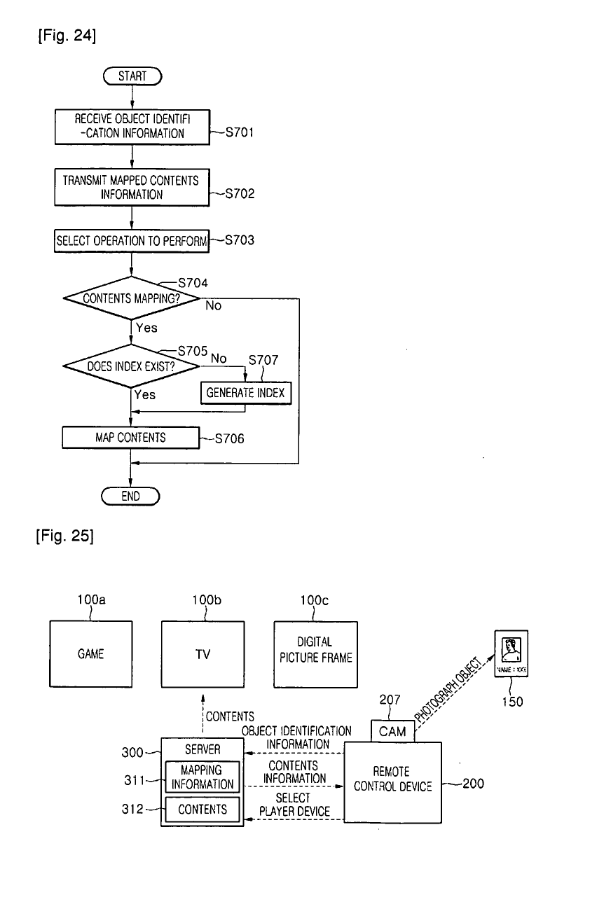

FIG. 25 illustrates a method for controlling contents by using object recognition according to further another exemplary embodiment.

In this embodiment, the server 300 stores mapping information and contents, and the user extracts identification information of an object by using a remote control device 200 mounted with a camera.

In FIG. 25, the remote control device 200 is used to extract identification information of an object, and it is transmitted to the server 300 storing the mapping information, thus making it possible to detect contents information mapped to the object. When the contents information are displayed, the contents information may be used to generate/display an enhanced image as illustrated in FIGS. 14 and 15

After detecting the contents information, the user may use the remote control device 200 to control operations such as contents mapping, contents playing and contents browsing. If the user is to perform a contents playing operation, the user uses the remote control device 200 to select the playback device, for example, the TV 100b and notifies the selection to the server 300. Then, the server 300 transmits contents to the selected playback device 100b, and the selected playback device 100b may play the contents.

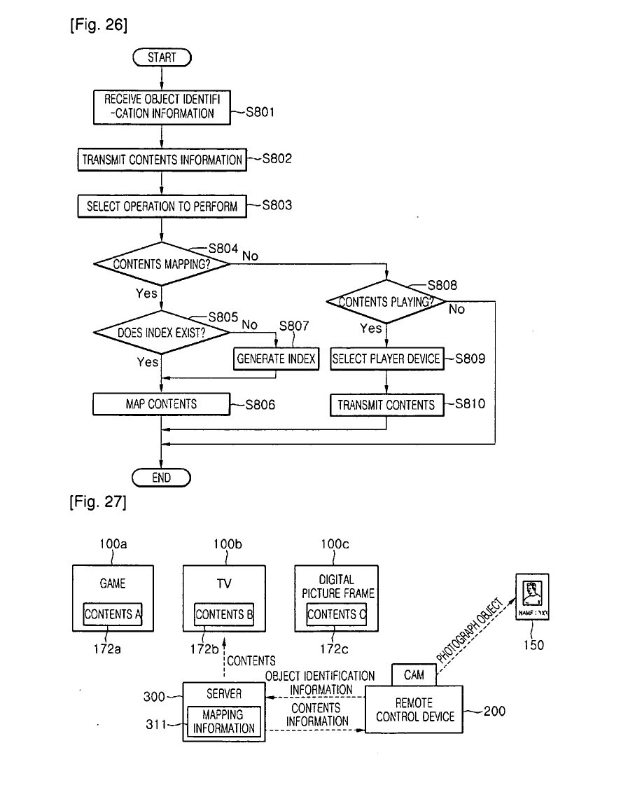

FIG. 26 is a flow diagram illustrating a method performed by the server 300 of FIG. 25 according to an exemplary embodiment.

In step S801, the method receives identification information of an object from the remote control device 200. In step S802, the method searches mapping information and transmits contents information mapped to the identified objet to the remote control device 200. In step S803, the user uses the remote control device 200 to select an operation to perform.

If an operation to perform is contents mapping (in step S804), the method proceeds to step S805. In step S805, the method determines whether an index of the object is present. If an index of the object is present, the method maps contents in step S806. On the other hand, if an index of the object is not present, the method generates the index to map contents in step S807.

If an operation to perform is contents playing (in step S808), the method proceeds to step S809. In step S809, the user selects a playback device. In step S810, the method transmits contents to the selected playback device to play the contents in the playback device.

FIG. 27 illustrates a method for controlling contents by using object recognition according to still further another exemplary embodiment.

In this embodiment, the server 300 stores mapping information, and the playback devices 100a, 100b and 100c store contents. The user extracts identification information of an object by using the remote control device 200, and transmits the extracted identification information to the server 300. In response to this, the server 300 transmits contents information to the remote control device 200. The remote control device 200 displays contents information including the location of the contents. The user detects the contents information to control the playback devices storing the contents, thus making it possible to control the contents stored in each of the playback devices.

The methods performed by the playback device 100, the remote control device 200 and the server 300 may be similar to those of the aforesaid embodiments. However, the communication from the server 300 to the playback device 100 is not generated, and the user may receive the contents mapping information from the server 300 through the remote control device 200 and may control the playback devices 100 on the basis of the received information.

The specific order of the steps of the aforesaid method is merely an example of an approach method. According to design preferences, the specific order or the hierarchical structure of the steps of the above process may be rearranged within the scope of this disclosure. Although the appended method claims provide various step elements in exemplary order, the present disclosure is not limited thereto.

Those skilled in the art will understand that various logic blocks, modules circuits and algorithm steps described with reference to the aforesaid embodiments may be implemented by electronic hardware, computer software or a combination thereof. In order to clearly describe the interchangeability between hardware and software, components, blocks, modules, circuits, units and steps are described by their general functions. Such functions may be implemented by hardware or software according to the design flexibility given to the total system and specific application fields.

Logic blocks, modules and circuits related to the aforesaid embodiments may be implemented or performed by general-purpose processors, digital signal processors (DSPs), ASICs, field programmable gate arrays (FPGAs), programmable logic devices, discrete gates, transistor logics, discrete hardware components, or a combination thereof. The general-purpose processors may be microprocessors, but the processors may be typical processors, controllers, microcontrollers, or state machines. The processor may be implemented by a computing device, for example, a combination of a DSP and a microprocessor, a plurality of microprocessors, one or more microprocessors coupled to a DSP core, or other devices.

The algorithm or the steps of the method described with reference to the aforesaid embodiments may be implemented by hardware, a software module executed by a processor, or a combination thereof. The software module may be resident in various storage media such as RAM, flash memory, ROM, EEPROM, register, hard disk, detachable disk, and CD-ROM. An exemplary storage medium (not illustrated) may be connected to a processor, and the processor may write/read data in/from the storage medium. Alternatively, the storage medium may be integrated into the processor. The processor and the storage medium may be located at an ASIC. The ASIC may be located at a user terminal. Alternatively, the processor and the storage medium may be independent of the user terminal.

In the aforesaid embodiments, the described functions may be implemented by hardware, software, firmware or a combination thereof.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A playback device comprising:
an image receiving unit receiving an image of an object;
a control unit extracting identification information of the object from the received image and performing a mapping-related operation between the object and contents on the basis of the extracted identification information;
a storage unit storing the contents and the mapping information between the object and the contents;
a user input unit receiving a user input; and
an image processing unit processing the contents into a displayable signal.

2. The playback device of claim 1, wherein the identification information of the object is the partial or entire image of the object.

3. The playback device of claim 1, wherein the identification information of the object is a unique code representing the object.

4. The playback device of claim 1, wherein the identification information receiving unit is a camera connecting unit or a camera connected to the playback device.

5. The playback device of claim 1, wherein the mapping-related operation is an operation of mapping the contents, selected by a user, to the object.

6. The playback device of claim 1, wherein the mapping-related operation is an operation of mapping the contents, currently played by the playback device, to the object.

7. The playback device of claim 1, wherein the mapping-related operation is an operation of playing the contents mapped to the object.

8. The playback device of claim 1, wherein the mapping-related operation is an operation of outputting information of the contents mapped to the object.

9. The playback device of claim 1, further comprising a display unit displaying an image outputted from the image processing unit.

10. A playback device comprising:
a Near Field Communication (NFC) unit receiving identification information of an object;
a control unit performing a mapping-related operation between the object and contents on the basis of the received identification information;
a storage unit storing the contents and the mapping information between the object and the contents;
a user input unit receiving a user input; and
an image processing unit processing the contents into a displayable signal.

11. The playback device of claim 10, wherein the identification information of the object is the partial or entire image of the object.

12. The playback device of claim 10, wherein the identification information of the object is a unique code representing the object.

13. The playback device of claim 10, wherein the NFC unit includes one of a WiFi communication module, a Bluetooth communication module, an RF communication module, a ZigBee communication module and an NFC module.

14. The playback device of claim 10, wherein the identification information receiving unit is a camera connecting unit or a camera connected to the playback device.

15. The playback device of claim 10, wherein the mapping-related operation is an operation of mapping the contents, selected by a user, to the object.

16. The playback device of claim 10, wherein the mapping-related operation is an operation of mapping the contents, currently played by the playback device, to the object.

17. The playback device of claim 10, wherein the mapping-related operation is an operation of playing the contents mapped to the object.

18. The playback device of claim 10, wherein the mapping-related operation is an operation of outputting information of the contents mapped to the object.

19. The playback device of claim 10, further comprising a display unit displaying an image outputted from the image processing unit.

20. A remote control device connected wirelessly to other devices to communicate data, comprising:
a camera unit photographing an image of an object;
a control unit extracting identification information of the object from the photographed image;
a user input unit receiving a user input;
a Near Field Communication (NFC) unit transmitting the extracted object identification information or the user input to the other devices; and
a display unit displaying the photographed object image.

21. The remote control device of claim 20, wherein the identification information of the object is the partial or entire image of the object.

22. The remote control device of claim 20, wherein the identification information of the object is a unique code representing the object.

23. The remote control device of claim 20, wherein the NFC unit receives information of the contents mapped to the object image, and the control unit generates/displays a virtual image representing the contents generated on the basis of the received contents information.

24. The remote control device of claim 20, wherein the NFC unit includes one of a WiFi communication module, a Bluetooth communication module, an RF communication module, a ZigBee communication module and an NFC module.

25. A playback device comprising:
an image receiving unit receiving an image of an object;
a control unit extracting identification information of the object from the image of the object;
a Near Field Communication (NFC) unit transmitting the identification information and receiving mapping-related information between the object and contents;
a user input unit receiving a user input; and
an image processing unit processing the mapping-related information between the object and the contents into a displayable signal.

26. The playback device of claim 25, wherein the identification information of the object is the partial or entire image of the object.

27. The playback device of claim 25, wherein the identification information of the object is a unique code representing the object.

28. The playback device of claim 25, wherein the image receiving unit is a camera connecting unit or a camera connected to the playback device.

29. The playback device of claim 25, wherein the mapping-related information is the contents mapped to the object.

30. The playback device of claim 25, wherein the mapping-related information is a list of contents mapped to the object.

31. The playback device of claim 25, wherein the mapping-related information is the mapped contents that are mapping information of the object.

32. The playback device of claim 25, further comprising a display unit displaying an image outputted from the image processing unit.

33. A multimedia data managing server connected wirelessly to one or more playback devices or remote control devices to manage multimedia data, comprising:
a Near Field Communication (NFC) unit receiving identification information of an object;
a control unit performing a mapping-related operation between the object and contents on the basis of the received object identification information;
a storage unit storing the mapping information between the object and the contents; and
a user input unit receiving a user input.

34. The multimedia data managing server of claim 33, wherein the storage unit stores the contents, and the mapping-related operation is an operation of transmitting the contents mapped to the object, among the contents stored in the storage unit, to one of the playback devices.

35. The multimedia data managing server of claim 33, wherein the playback device receiving the contents is the playback device that transmitted to the identification information to the multimedia data managing server.

36. The multimedia data managing server of claim 33, wherein the NFC unit receives a selection input of the playback device, and the playback device receiving the contents is the playback device selected by the selection input.

37. The multimedia data managing server of claim 33, wherein the mapping-related operation is an operation of transmitting the contents information mapped to the object to one of the playback device and the remote control device.

38. The multimedia data managing server of claim 37, wherein the device receiving the contents information is the device that transmitted to the identification information to the multimedia data managing server.

39. A method for providing a user interface for control of multimedia contents in a playback device that stores contents and the mapping information between an object and the contents, comprising:
receiving an image of an object;
extracting identification information of the object from the received image;
displaying a mapping-related menu between the object and the contents;
receiving a selection input from a user; and
performing a mapping-related operation between the object and the contents on the basis of the extracted identification information.

40. The method of claim 39, wherein the mapping-related operation is an operation of mapping the contents, selected by the user, to the object.

41. The method of claim 39, wherein the mapping-related operation is an operation of mapping the contents, currently played by the playback device, to the object.

42. The method of claim 39, wherein the mapping-related operation is an operation of playing the contents mapped to the object.

43. A method for providing a user interface for control of multimedia contents in a playback device that stores contents and the mapping information between an object and the contents, comprising:
receiving identification information of an object;
displaying a mapping-related menu between the object and the contents;
receiving a selection input from a user; and
performing a mapping-related operation between the object and the contents on the basis of the extracted identification information.

44. The method of claim 43, wherein the mapping-related operation is an operation of mapping the contents, selected by the user, to the object.

45. The method of claim 43, wherein the mapping-related operation is an operation of mapping the contents, currently played by the playback device, to the object.

46. The method of claim 43, wherein the mapping-related operation is an operation of playing the contents mapped to the object.
